(19) United States
(12) Patent Application Publication
(10) Pub. No.: US 2014/0205410 A1
(43) Pub. Date: Jul. 24, 2014

(54) DAMPED OFFLOAD SYSTEM

(71) Applicant: GM GLOBAL TECHNOLOGY OPERATIONS LLC, Detroit, MI (US)

(72) Inventor: Chet R. Wisniewski, Royal Oak, MI (US)

(73) Assignee: GM Global Technology Operations LLC, Detroit, MI (US)

(21) Appl. No.: 13/748,137

(22) Filed: Jan. 23, 2013

(51) Int. Cl. B60P 1/44

(52) U.S. Cl. CPC B60P 1/44
USPC 414/541; 414/812

(57) ABSTRACT

One variation may include a product including a carrier having a doorway constructed and arranged so that a module or second container may be loaded into and out the carrier through the doorway, the carrier being movable, and wherein the carrier is constructed and arranged so that the doorway is in an elevated position, a bracket positioned to receive a module or second container, a lift system connected to the bracket and constructed and arranged to lift the bracket and the module or second container to a position wherein the module or second container may be inserted through the doorway and into a carrier, and to lower the bracket and the module or second container to a position wherein the module or second container is below at least a portion of the doorway and so that the second module or container may be removed from the bracket.

### TECHNICAL FIELD

The field to which the disclosure generally relates to includes systems or products including a carrier constructed and arranged so that a plurality of modules or second containers may be loaded into and out of the carrier.

### BACKGROUND

Industrial dampers have been used in various applications from automotive tailgates to vehicle suspensions.

### SUMMARY OF ILLUSTRATIVE VARIATIONS OF THE INVENTION

One variation may include a product including a carrier having a doorway constructed and arranged so that a module or second container may be loaded into and out of the carrier through the doorway, carrier being movable and wherein the carrier is constructed arranged so that the doorway is in an elevated position, a bracket positioned to receive a module or second container, a lift system connected to the bracket and constructed and arranged and lift the bracket and the module or second container to a position wherein the module or second container may be inserted through the doorway and into a carrier, and to lower the bracket and the module or second container to a position wherein the module or second container is below an upper portion of the doorway and so that the second module or container may be removed from the bracket.

In one variation the bracket may be pivotal so that the module may be swung away from the doorway.

In one variation the bracket may be pivotally connected to the carrier.

In one variation the bracket may be pivotally connected to a movable flatbed or wagon.

One variation may include a plurality of wheels connected to the carrier so that the carrier is movable.

One variation may include a spring connected to the bracket to bias the bracket upward.

One variation may include a damping system constructed and arranged to controllably lower the bracket and the module or second container to a position wherein at least a portion of the module or second container is below an upper portion of the doorway.

In one variation the damping system may include a pneumatic or hydraulic system.

In one variation the damping system may include a magnetorheological or electrorheological damper.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a perspective view of a product including a carrier constructed and arranged so that a plurality of modules or second containers may be loaded into an out of the carrier according to a number of variations of the invention.

FIG. 2 is a perspective view of product illustrated in FIG. 1 illustrating a module or second container attached to a bracket and swung out away from a doorway of the carrier according to a number of variations of the invention.

FIG. 3 is a perspective view of the product illustrated in FIG. 2 illustrating the module or second container lowered to a position below the doorway of the carrier wherein the module or second container may be removed from the bracket according to a number of variations of the invention.

FIG. 4 is an enlarged view with portions broken away of a damping system according to a number of variations of the invention.

FIG. 5 is a partial end view illustrating the module or second container received on the bracket according to a number of variations of the invention.

FIG. 6 is a sectional view illustrating mating locking features on the module or second container and the bracket according to a number of variations of the invention.

FIG. 7 is a schematic illustrating a pneumatic system for lifting and lowering the bracket according to a number of variations of the invention.

### DETAILED DESCRIPTION OF ILLUSTRATIVE VARIATIONS OF THE INVENTION

The following description of the variations is merely illustrative in nature and is in no way intended to limit the invention, its application, or uses.

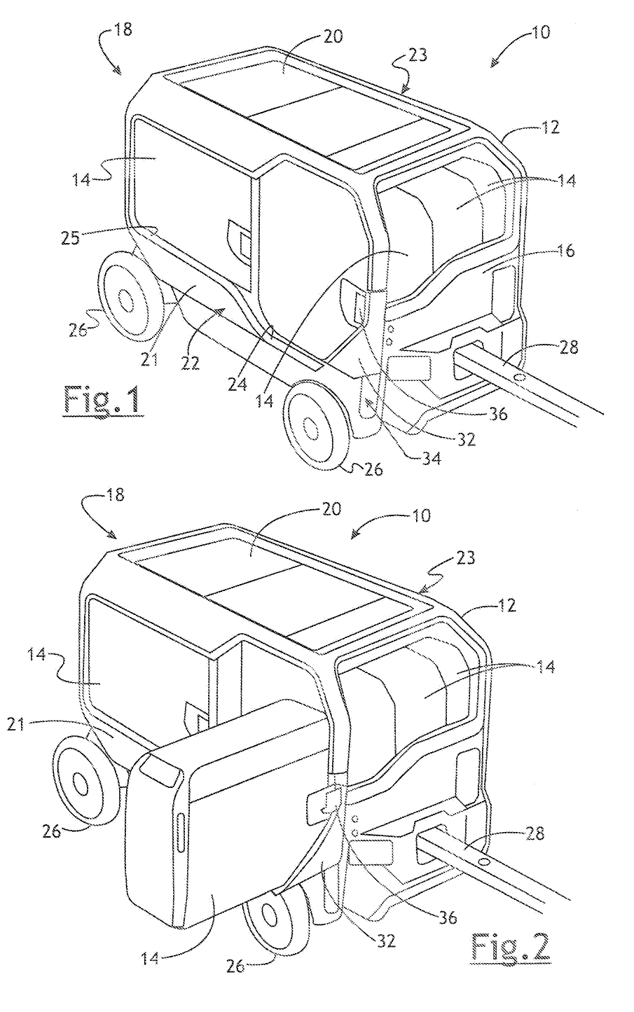

Referring now to FIGS. 1 and 5, a number of variations of the invention may include a system or product 10 including a carrier 12. The carrier 12 may include a front face 16, and opposite rear face 18, a roof 20, a floor 22, a first side face 21, and an opposite second side face 23 connected together to form the carrier 12. A doorway 24 may be formed in the carrier 12, for example, but not limited to one of the first side face 21 or second side face 23. The doorway 24 may be in an elevated position above the ground. Optionally, a window 23 may be formed in one of the first side face 21 or second side face 23 and may communicate with the doorway 24. In a number of variations the carrier 12 may be mobile. In one variation a plurality of wheels may be attached to the carrier 12 so that the container may be moved manually or by one or more electric motors or a combustion engine operatively connected to the wheels 26. In a number of other variations, the carrier 12 may be received on a movable flatbed or wagon. A handle or hitch 28 may be pivotally connected to the carrier 12 or the flatbed or wagon. A bracket 32 may be provided and may be constructed and arranged to receive the module or second container 14 thereon. As illustrated by FIG. 5, in a number of variations a portion of the bracket 32 may have an L-shaped portion so that the module or second container 22 may rest on the L-shaped portion of the bracket 32.

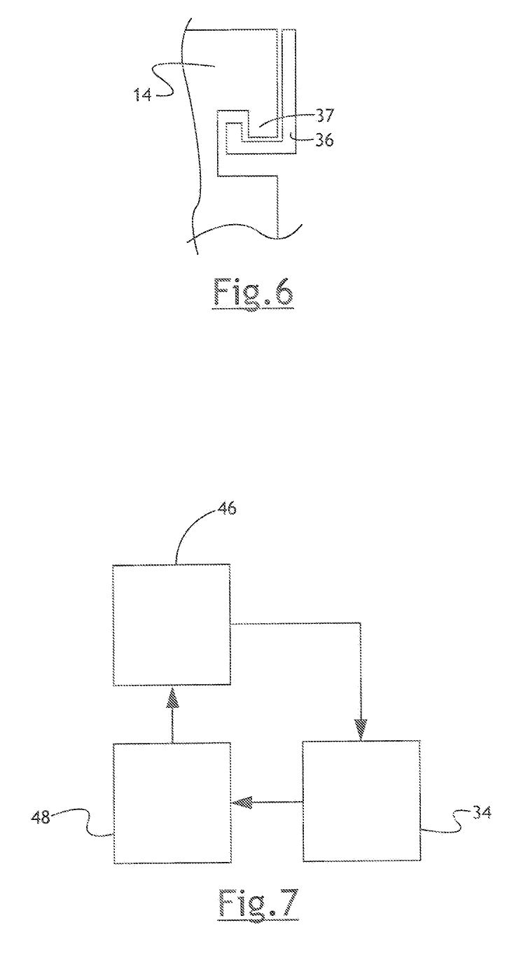

Referring to FIG. 6, the module or second container 14 and the bracket 32 may include mating locking features to secure or releasable lock the module or second container 14 to the bracket 32. In a number of variations, the module or second container 14 may include a lip 37 on to which a biased latch 36 may be releasably locked to secure the module or second container 14 to the bracket 32.

Referring now to FIGS. 4 and 7, a damper system 34 may be operatively connected to the bracket 32 to at least assist in controllably lowering the bracket from one position to another. In a number of variations the damper system 34 may also be used to raise the bracket from one position to another. In a number of variations of the invention the damping system 34 may include a pneumatic piston 40 having a plurality of openings formed therein. One or more valves 43, for example gate valves, may be associated with the plurality of openings. The valves 43 may be selectively opened or closed manually or by a controller 48 as illustrated in FIG. 7. An air pump 48 may be operatively connected to the damping system 34 to lift the bracket 32 from one position to another. To lower the bracket 32 from one position to another, the valves 43 may be opened to allow air to escape through the openings 42 in the piston 40. A spring 38 may be positioned between a piston cylinder 50 and a collar portion 44 of the bracket 32 to bias the bracket 32 in an upward direction. In a number of other variations the damping system 34 may include a hydraulic, magnetorheological or electrorheological damper constructed and arranged so that the bracket 32 may be lowered in a controlled and relative slow manner.

Referring now to FIG. 2, in a number of variations the carrier 12 may have received therein a plurality of modules or second containers 14 positioned in a side-by-side relationship. The modules or second containers 14 may be generally rectangular in cross-section and may have opposite elongated sides. One of the modules or second containers 14 may be moved onto the bracket 32 and locked thereto. The bracket 32 may be swung so that the module or second container 14 is moved through the doorway 24 and so that the elongated sides of the module or second container 14 are in a generally perpendicular position with respect to the first side faced 21 or second side face 23 of the carrier 12. The bracket 32 may be swung either manually by an operator or by using a power assist system including an electric motor, hydraulic piston, or a pneumatic system.

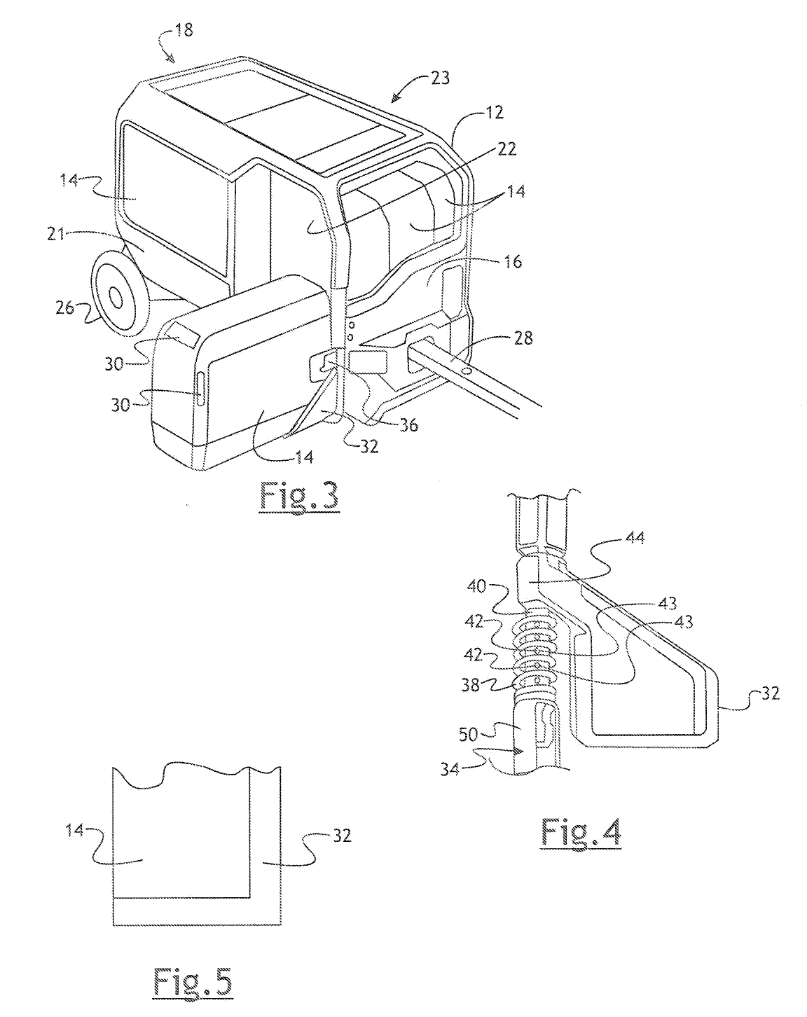

As illustrated in FIG. 3, in a number of variations the bracket 32 with the module or second container 14 thereon may be lowered to a position where at least a portion of the module or second container 14 is below the doorway 24 of the carrier 12 and so that the module or second container 14 may be removed from the bracket 32. The module or second container 14 may include rollers or wheels to facilitate easy movement of the module or second container 14. The module or second container 14 may include one or more openings 34 receiving letters, envelopes, or packages.

In a number of variations pre-packaged modules or second containers 14 may be arranged in the carrier 12 to optimize delivery at one corner of the carrier 12. The number of variations, the carrier 12 may be a transport vehicle. The module or second container 14 may be latched onto the corner bracket 32 which bears the weight of the module or second container 14 and its contents. The product or system may be particularly advantageous for delivery of prepackaged modules along the curb or a street or other location with a restricted area for loading and unloading the module or second container 14.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising a carrier having a doorway constructed and arranged so that a module or second container may be loaded into and out the carrier through the doorway, the carrier being movable, and wherein the carrier is constructed arranged so that the doorway is in an elevated position, a bracket positioned to receive the module or second container, a lift system connected to the bracket and constructed and arranged to lift the bracket and the module or second container to a position wherein the module or second container may be inserted through the doorway and into a carrier, and to lower the bracket and the module or second container to a position wherein the module or second container is below an upper portion of the doorway and so that the second module or container may be removed from the bracket.

Variation 2 may include a product as set forth in Variation 1 wherein the bracket is constructed and arranged so that the module or second container resting on the bracket may be swung away from the doorway.

Variation 3 may include a product as set forth in Variations 1-2 wherein the bracket is pivotally connected to the carrier and is constructed and arranged so that the module or second container resting on the bracket may be swung away from the doorway.

Variation 4 may include a product as set forth in claim 1-3 wherein the bracket is pivotally connected to a movable flatbed or wagon.

Variation 5 may include a product as set forth in Variations 1-4 further comprising a plurality of wheels connected to the carrier so that the carrier is movable.

Variation 6 may include a product as set forth in Variations 1-5 further comprising a spring connected to the bracket to bias the bracket upward.

Variation 7 may include a product as set forth in Variation 1-6 further comprising a damping system constructed arranged to controllably lower the bracket and the module or second container to a position wherein at least a portion of the module or second container is below an upper portion of the doorway.

Variation 8 may include a product as set forth in Variations 1-7 wherein the damping system comprises a hydraulic or pneumatic system.

Variation 9 may include a product as set forth in Variations 1-8 wherein the damping system comprises a magnetorheological or electrorheological damper.

Variation 10 may include a product as set forth in Variations 1-9 wherein the pneumatic system include a pneumatic piston having a plurality of openings therein to allow air to flow out of the piston as the bracket is lowered and at least one valve to selectively open and closes the opening in the piston.

Variation 11 may include a product as set forth in Variations 1-10 wherein the bracket and the module or second container have mating locking features to releasably lock the module or second container to the bracket.

Variation 12 may include a method comprising providing a carrier having a doorway constructed and arranged so that a module or second container may be loaded into and out of the carrier through the doorway, the carrier being movable, and wherein the carrier is constructed and arranged so that the doorway is in an elevated position, a bracket positioned to receive a module or second container, a lift system connected to the bracket and constructed and arranged to lift the bracket and the module or second container to a position wherein the module or second container may be inserted through the doorway and into a carrier, and to lower the bracket and the module or second container to a position wherein the module or second container is below at least a portion of the doorway and so that the second module or container may be removed from the bracket; loading the module or second container into the carrier comprising swinging the bracket outwardly away from the door opening and lowering the bracket to a position below the doorway wherein the bracket is in a first position; placing the module or second container on the bracket while the bracket is in the first position so that the module or second container rest on the bracket; lifting the bracket with the module or second container resting thereon to a second position wherein the module or second container is in vertical alignment with the doorway; swinging the bracket with the module or second container resting thereon so that the module or second container is moved through the doorway; removing the module or second container from the bracket and positioning the module or second container in the carrier.

Variation 13 may include a method as set forth in Variation 12 further comprising unloading the module or second container from the carrier comprising placing the module or second container on the bracket so that the module or second container is resting on the bracket; swinging the bracket outward away from the doorway so that the module or second container is in a position wherein the elongated sides of the module or second container are generally perpendicular to the first side face and second side face of the carrier; lowering the bracket so that at least a portion of the module or second container is below an upper portion of the doorway and removing the module or second container from the bracket.

Variation 14 may include a method as set forth in Variations 12-13 wherein the bracket is pivotally connected to the carrier and is constructed and arranged so that the bracket may be swung away from the doorway.

Variation 15 may include a method as set forth in Variations 12-14 further comprising providing a movable flatbed or wagon and placing the carrier on the movable flatbed or wagon, and wherein the bracket is pivotally connected to a movable flatbed or wagon.

Variation 16 may include a method as set forth in Variations 12-15 further comprising providing a plurality of wheels connected to the carrier so that the carrier is movable.

Variation 17 may include a method as set forth in Variations 12-16 further comprising providing a spring connected to the bracket to bias the bracket upward.

Variation 18 may include a method as set forth in Variations 12-17 further comprising providing a damping system constructed and arranged to controllably lower the bracket and the module or second container to a position wherein at least a portion of the module or second container is below an upper portion of the doorway.

Variation 19 may include a method as set forth in claim 18 wherein the damping system comprises a pneumatic system.

Variation 20 may include a method as set forth in Variation 19 wherein the pneumatic system include a pneumatic piston having a plurality of openings therein to allow air to flow out of the piston as the bracket is lowered and at least one valve to selectively open and close the openings in the piston.

The above description of select examples of the invention is merely exemplary in nature and, thus, variations or variants thereof are not to be regarded as a departure from the spirit and scope of the invention.

What is claimed is:

1. A product comprising a carrier having a doorway constructed and arranged so that a module or second container may be loaded into and out carrier through the doorway, the carrier being movable, and wherein the carrier is constructed and arranged so that the doorway is in an elevated position, a bracket positioned to receive the module or second container, a lift system connected to the bracket and constructed and arranged to lift the bracket and the module or second container to a position wherein the module or second container may be inserted through the doorway and into a carrier, and to lower the bracket and the module or second container to a position wherein the module or second container is below an upper portion of the doorway and so that the second module or container may be removed from the bracket.

2. A product as set forth in claim 1 wherein the bracket is constructed and arranged so that the module or second container resting on the bracket may be swung away from the doorway.

3. A product as set forth in claim 1 wherein the bracket is pivotally connected to the carrier and is constructed and arranged so that the module or second container resting on the bracket may be swung away from the doorway.

4. A product as set forth in claim 1 wherein the bracket is pivotally connected to a movable flatbed or wagon.

5. A product as set forth in claim 1 further comprising a plurality of wheels connected to the carrier so that the carrier is movable.

6. A product as set forth in claim 1 further comprising a spring connected to the bracket to bias the bracket upward.

7. A product as set forth in claim 1 further comprising a damping system constructed arranged to controllably lower the bracket and the module or second container to a position wherein at least a portion of the module or second container is below an upper portion of the doorway.

8. A product as set forth in claim 7 wherein the damping system comprises a pneumatic system.

9. A product as set forth in claim 7 wherein the damping system comprises a magnetorheological or electrorheological damper.

10. A product as set forth in claim 8 wherein the pneumatic system include a pneumatic piston having a plurality of openings therein to allow air to flow out of the piston as the bracket is lowered and at least one valve to selectively open and close the opening in the piston.

11. A product as set forth in claim 1 wherein the bracket and the module or second container have mating locking features to releasably lock the module or second container to the bracket.

12. A method comprising providing a carrier having a doorway constructed and arranged so that a module or second container may be loaded into and out the carrier through the doorway, the carrier being movable, and wherein the carrier is constructed and arranged so that the doorway is in an elevated position, a bracket positioned to receive a module or second container, a lift system connected to the bracket and constructed and arranged to lift the bracket and the module or second container to a position wherein the module or second container may be inserted through the doorway and into a carrier, and to lower the bracket and the module or second container to a position wherein the module or second container is below at least a portion of the doorway and so that the second module or container may be removed from the bracket;
loading the module or second container into the carrier comprising swinging the bracket outwardly away from the door opening and lowering the bracket to a position below the doorway wherein the bracket is in a first position;
placing the module or second container on the bracket while the bracket is in the first position so that the module or second container rest on the bracket;
lifting the bracket with the module or second container resting thereon to a second position wherein the module or second container is in vertical alignment with the doorway;
swinging the bracket with the module or second container resting thereon so that the module or second container is moved through the doorway;
removing the module or second container from the bracket and positioning the module or second container in the carrier.

13. A method as set forth in claim 12 further comprising unloading the module or second container from the carrier comprising placing the module or second container on the bracket so that the module or second container is resting on the bracket;
swinging the bracket outward away from the doorway so that the module or second container is in a position wherein the elongated sides of the module or second container are generally perpendicular to the first side face and second side face of the carrier;
lowering the bracket so that at least a portion of the module or second container is below the doorway and removing the module or second container from the bracket.

14. A method as set forth in claim 12 wherein the bracket is pivotally connected to the carrier and is constructed and arranged so that the module or carrier resting on the bracket may be swung away from the doorway.

15. A method as set forth in claim 12 further comprising providing a movable flatbed or wagon and placing the carrier on the movable flatbed or wagon, and wherein the bracket is pivotally connected to a movable flatbed or wagon.

16. A method as set forth in claim 12 further comprising providing a plurality of wheels connected to the carrier so that the carrier is movable.

17. A method as set forth in claim 12 further comprising providing a spring connected to the bracket to bias the bracket upward.

18. A method as set forth in claim 12 further comprising providing a damping system constructed arranged to controllably lower the bracket and the module or second container to a position wherein at least a portion of the module or second container is below an upper portion of the doorway.

19. A method as set forth in claim 18 wherein the damping system comprises a pneumatic system.

20. A method as set forth in claim 19 wherein the pneumatic or hydraulic system include a piston having a plurality of openings therein to allow air to flow out of the piston as the bracket is lowered and at least one valve to selectively open and closes the opening in the piston.
